(19) United States
(12) Patent Application Publication
(10) Pub. No.: US 2020/0184782 A1
(43) Pub. Date: Jun. 11, 2020

(54) POINT OF SALE (POS) SYSTEM, MASTER DATA MAINTENANCE METHOD AND POS TERMINAL DEVICE

(71) Applicant: NEC Platforms, Ltd., Kawasaki-shi, Kanagawa (JP)

(72) Inventor: Takuya HIRAO, Kanagawa (JP)

(73) Assignee: NEC Platforms, Ltd., Kawasaki-shi, Kanagawa (JP)

(21) Appl. No.: 16/333,456

(22) PCT Filed: Oct. 6, 2017
(86) PCT No.: PCT/JP2017/036419

§ 371 Date: Mar. 14, 2019

(30) Foreign Application Priority Data
Oct. 11, 2016 (JP) 2016-199981

(51) Int. Cl. G07G 1/14; G07G 1/00; G06Q 20/20

(52) U.S. Cl. CPC G07G 1/14; G06Q 20/201; G06Q 20/202; G07G 1/0009

(57) ABSTRACT

This POS system, in which a shop machine installed in a shop and performing a process related to a product sale and a head office machine installed in a head office are connected to be capable of data communication via a network, can perform, through the shop machine and head office machine, maintenance on master data that is used when the shop machine performs a process related to the product sale. The head office machine is provided with: a head office-side control unit; and a head office-side storage unit which holds head office master data. The shop machine is provided with: a shop-side control unit; and a shop-side storage unit which holds in-use shop master data that is currently being used and shop master data before application, which is subjected to maintenance in the head office machine or the shop machine. The shop-side control unit transmits, to the head office machine, the corresponding in-use shop master data, in response to switching the shop master data before application to the in-use shop master data. The head office-side control unit stores, in the head office-side storage unit, the in-use shop master data received from the shop machine, as new head office master data.

### TECHNICAL FIELD

This invention relates to a POS system, a master data maintenance method, and a POS terminal device.

### BACKGROUND ART

A POS (Point of Sale) terminal device, which is configured to perform registration processing and payment processing on a product to be purchased by a customer, refers to data on the product (hereinafter referred to as “product master data”) stored in advance in a product master file at the time of performing the registration processing and the payment processing. In the product master file, the product master data, in which a product code, product name, unit price, and other such data on a product is associated with the product, is stored. In a head office and each shop, in order to, for example, register data on a new product, or to change the price of a product, it is required to perform maintenance (e.g., addition, change, or deletion of data on a product) on the product master data as required.

A POS system includes a plurality of POS terminal devices (shop machines) installed at a plurality of shops, respectively, and an information processing device (head office machine) capable of communicating data to/from those shop machines via a network and being installed at a head office of the shops. In such a POS system, maintenance is performed on the product master data in both of the shop machine and the head office machine. Herein, a product master file of the shop machine is referred to as “shop master file”, and product master data stored in the shop master file is referred to as “shop master data”. Further, a product master file of the head office machine is referred to as “head office master file”, and product master data stored in the head office master file is referred to as “head office master data”. Still further, maintenance to be performed on the shop master data in the shop machine is referred to as “shop maintenance”, and maintenance to be performed on the head office master data in the head office machine is referred to as “head office maintenance”. In such a POS system, it is required to achieve consistency between the shop master data and the head office master data.

In Patent Document 1, there is disclosed a product sale data processing system, in which a collection request is transmitted to each shop machine before head office maintenance is performed on head office master data and shop master data on which shop maintenance has been finished in each shop machine is reflected in the head office master data.

### CITATION LIST

### Patent Literature

Patent Literature 1: JP 11-328537 A

### SUMMARY OF INVENTION

### Technical Problem

However, in the product sale data processing system described in Patent Document 1, the head office maintenance can be performed only after the collection request is transmitted to each shop machine before the head office maintenance is performed on the head office master data and the received shop master data on which the shop maintenance has been finished is reflected in the head office master data.

It is an object of this invention to provide a POS system allowed to perform head office maintenance without collecting master data from a shop machine when head office maintenance is performed on head office master data in a head office machine.

### Means to Solve the Problem

According to a first aspect of the invention, there is provided a POS system, comprising a shop machine installed in a shop and configured to perform processing related to a product sale, and a head office machine installed in a head office, the shop machine and the head office machine being connected to each other via a network in a manner that enables data communication to/from each other, the POS system being capable of performing, in the head office machine and the shop machine, maintenance on master data to be used when the shop machine performs the processing related to the product sale, wherein the head office machine includes a head office-side control unit; and a head office-side storage unit configured to hold head office master data, wherein the shop machine includes a shop-side control unit; and a shop-side storage unit configured to hold in-use shop master data, which is currently used, and shop master data before application, which has been subjected to maintenance in the head office machine or the own shop machine, wherein the shop-side control unit is configured to transmit the in-use shop master data to the head office machine when the shop master data before application is determined as being usable as the in-use shop master data, and wherein the head office-side control unit is configured to store the in-use shop master data received from the shop machine into the head office-side storage unit as new head office master data.

According to a second aspect of the present invention, there is provided a master data maintenance method, which is executed in a configuration in which a shop machine installed in a shop and configured to perform processing related to a product sale and a head office machine installed in a head office are connected to each other via a network in a manner that enables data communication to/from each other and, in the head office machine and the shop machine, maintenance is performed on master data to be used when the shop machine performs the processing related to the product sale, the master data maintenance method comprising the steps of transmitting, by the shop machine, when shop master data before application that has been subjected to maintenance in the head office machine or the own shop machine is determined as being usable in the own shop machine as in-use shop master data, the in-use shop master data to the head office machine; and storing, by the head office machine, the received in-use shop master data into a head office-side storage unit as new head office master data.

According to a third aspect of the present invention, there is provided a POS terminal device, which is connected to a head office machine installed in a head office via a network in a manner that enables data communication to/from the head office machine and is installed in a shop, the POS terminal device being allowed to perform maintenance on master data to be used when the POS terminal device performs processing related to a product sale, the POS terminal device comprising a shop-side control unit; and a shop-side storage unit configured to hold in-use shop master data, which is currently used, and shop master data before application, which has been subjected to maintenance in the head office machine or the own shop machine, wherein, when the shop master data before application is determined as being usable as the in-use shop master data, the shop-side control unit transmits the in-use shop master data to the head office machine.

### Advantageous Effect of Invention

According to this invention, it is possible to provide the POS system capable of performing head office maintenance without collecting master data from a shop machine when head office maintenance is performed on head office master data in a head office machine.

### BRIEF DESCRIPTION OF DRAWINGS

FIG. 1 is a block diagram for illustrating a configuration of a POS system according to a first example embodiment of this invention.

FIG. 2 is a block diagram for illustrating a configuration of a head office machine in the first example embodiment of this invention.

FIG. 3 includes conceptual diagrams for illustrating details of product master data held by a head office-side storage unit in the first example embodiment of this invention, in which (a) is a conceptual diagram for illustrating details of the head office-side storage unit, (b) is a conceptual diagram for illustrating details of individual shop product master data, (c) is a conceptual diagram for illustrating details of product master data before application, and (d) is a conceptual diagram for illustrating details of individual shop data.

FIG. 4 includes block diagrams for illustrating a configuration of a shop machine in the first example embodiment of this invention, in which (a) is a block diagram for illustrating the configuration of the shop machine, and (b) is a block diagram for illustrating data held by a shop-side storage unit.

FIG. 5 is a flowchart for illustrating a flow of processing to be executed when maintenance is performed on the product master data in the head office machine in the first example embodiment of this invention.

FIG. 6 is a flowchart for illustrating a flow of processing to be executed when the product master data held by the head office machine is loaded in the shop machine in the first example embodiment of this invention.

FIG. 7 is a flowchart for illustrating a flow of processing to be executed when maintenance is performed on the product master data in the shop machine in the first example embodiment of this invention.

FIG. 8 is a flowchart for illustrating a flow of processing to be executed when the product master data before application is applied in the shop machine in the first example embodiment of this invention.

FIG. 9 is a flowchart for illustrating a flow of processing to be executed when the product master data has been received from the shop machine in the head office machine in the first example embodiment of this invention.

FIG. 10 includes conceptual diagrams for illustrating the product master data before being subjected to maintenance in the head office machine in the first example embodiment of this invention, in which (a) is a conceptual diagram for illustrating details of the head office-side storage unit, (b) is a conceptual diagram for illustrating details of the individual shop product master data, and (c) is a conceptual diagram for illustrating details of the individual shop data.

FIG. 11 includes conceptual diagrams for illustrating the product master data after having been subjected to maintenance in the head office machine in the first example embodiment of this invention, in which (a) is a conceptual diagram for illustrating details of the head office-side storage unit, (b) is a conceptual diagram for illustrating details of the individual shop product master data. (c) is a conceptual diagram for illustrating details of the product master data before application, and (d) is a conceptual diagram for illustrating details of the individual shop data.

FIG. 12 includes conceptual diagrams for illustrating details of product master data held by a head office-side storage unit in a second example embodiment of this invention, in which (a) is a conceptual diagram for illustrating details of the head office-side storage unit, (b) is a conceptual diagram for illustrating details of individual shop product master data, (c) is a conceptual diagram for illustrating details of individual shop data.

FIG. 13 is a flowchart for illustrating a flow of processing to be executed when maintenance is performed on the product master data in the head office machine in the second example embodiment of this invention.

FIG. 14 is a flowchart for illustrating a flow of processing to be executed when the product master data has been received from the shop machine in the head office machine in the second example embodiment of this invention.

FIG. 15 is a block diagram for illustrating a configuration of each of a head office machine and a shop machine in another example embodiment of this invention.

FIG. 16 is a block diagram for illustrating a basic idea of this invention.

### DESCRIPTION OF EMBODIMENTS

Now, embodiments of this invention will be described in detail with reference to the drawings. In order to avoid repetition to simplify the description, the same or corresponding portions are denoted by the same reference symbols in the respective figures, and the description thereof is omitted as appropriate.

[Basic Idea]

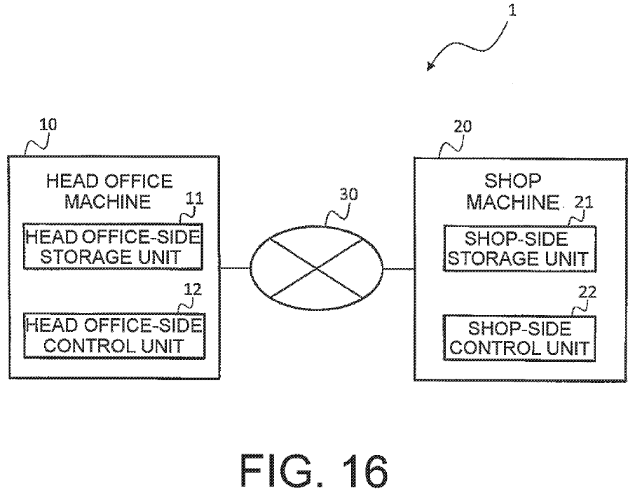

First, in order to facilitate understanding of embodiments of this invention, a description is given of a basic idea of this invention with reference to FIG. 16. FIG. 16 is a conceptual diagram of a POS system, for illustrating the basic idea of this invention.

As illustrated in FIG. 16, a POS system 1 includes a head office machine 10 and a shop machine 20. The head office machine 10 is, for example, an information processing device constructed of a computer. The shop machine 20 is, for example, a POS terminal device constructed of a computer. That is, in the POS system 1, the shop machine 20 is installed at each shop, and the head office machine 10 is installed at a head office of each shop at which the shop machine 20 is installed. The head office machine 10 and the shop machine 20 are connected to each other via a network 30 in a manner that allows communication to/from each other. The network 30 is not particularly limited, and is only required to be a communication network, for example, the Internet. In FIG. 16, the head office machine 10 is illustrated as being connected to one shop machine 20, but this is merely an example, and the head office machine 10 may be connected to a plurality of shop machines 20.

First, a description is given of the head office machine 10. The head office machine 10 includes a head office-side storage unit 11 and a head office-side control unit 12.

The head office-side storage unit 11 holds various types of product master data to be used by the shop machine 20 when processing related to a product sale is executed. Specifically, the head office-side storage unit 11 holds, for example, product master data for the shop machine 20 of the first version to the latest version, product master data on which maintenance has been performed by the head office-side control unit 12 described later and before being applied to the shop machine 20 (before being used by the shop machine 20), product master data currently used by the shop machine 20, and sales data. The product master data for each shop at which the shop machine 20 is installed may be referred to as “shop master data”. The product master data on which maintenance has been performed by the head office-side control unit 12 and before being applied to the shop machine 20 may be referred to as “shop master data before application”. The data for each shop (individual shop data) is described as including the sales data, but the individual shop data may not include the sales data.

The head office-side control unit 12 controls various types of functions of the head office machine 10. When the head office-side control unit 12 receives from the shop machine 20 the product master data currently used by the shop machine 20, the head office-side control unit 12 stores the received data into the head office-side storage unit 11 as head office master data. Further, the head office-side control unit 12 stores the latest head office master data on which maintenance has been performed into the head office-side storage unit 11 as head office master data before application.

Next, a description is given of the shop machine 20. The shop machine 20 includes a shop-side storage unit 21 and a shop-side control unit 22.

The shop-side storage unit 21 holds, for example, in-use shop master data currently used by the shop machine 20, the shop master data before application on which maintenance has been performed in the head office machine 10 or the shop machine 20, and sales data.

The shop-side control unit 22 controls various types of functions of the shop machine 20. When the shop master data before application is determined as being usable in the shop machine 20, the shop-side control unit 22 transmits the shop master data before application to the head office machine 10 as the in-use shop master data. Further, the shop-side control unit 22 stores product master data on which maintenance has been performed in the head office machine 10 and product master data on which maintenance has been performed in the shop machine 20 into the shop-side storage unit 21 as the shop master data before application.

With the configuration of the POS system 1 described above, the head office machine 10 can perform maintenance on the product master data without collecting the product master data from the shop machine 20.

Now, with reference to the drawings, example embodiments of this invention will be described in detail.

### First Example Embodiment

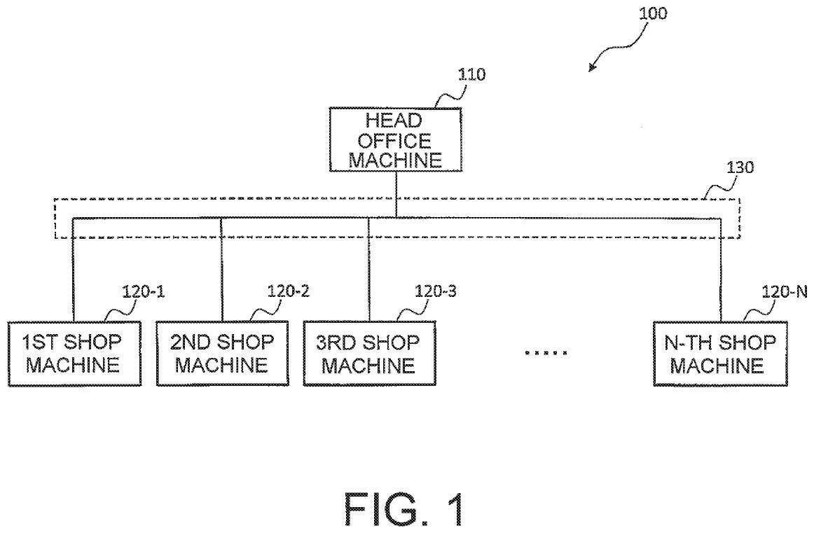

A first example embodiment will be described with reference to FIG. 1 to FIG. 11.

FIG. 1 is a schematic diagram for illustrating a configuration of a POS system 100 according to the first example embodiment. The POS system 100 includes a head office machine (information processing device) 110 installed at a head office of shops, and a first shop machine (POS terminal device) 120-1, a second shop machine 120-2, a third shop machine 120-3, . . . and an N-th shop machine 120-N installed at the respective shops. That is, the POS system 100 includes one head office machine and N (N is an integer of 1 or more) shop machines.

The head office machine 110 and the first shop machine 120-1 to the N-th shop machine 120-N are configured to be capable of communicating data to/from one another via a network (e.g., ISDN (Integrated Services Digital Network)) 130. The network 130 is not particularly limited, and may be another communication network that enables data communication (e.g., the Internet).

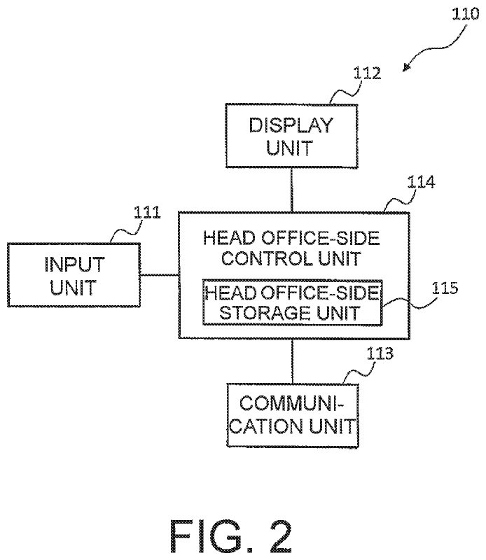

Referring to FIG. 2, a description is given of a configuration of the head office machine 110 in the first example embodiment. FIG. 2 is a block diagram for illustrating a configuration of the head office machine 110.

As illustrated in FIG. 2, the head office machine 110 includes an input unit 111 configured to receive input of data and the like, a display unit 112 configured to display a result of information processing and the like, a communication unit 113 configured to communicate to/from other apparatus, and a head office-side control unit 114 configured to perform overall control of the head office machine 110. Further, the head office-side control unit 114 includes a head office-side storage unit 115 configured to hold an application program and the like. The following description assumes that the head office-side control unit 114 includes the head office-side storage unit 115, but this is merely an example and does not limit this invention. The head office-side storage unit 115 may be provided outside the head office-side control unit 114. The head office machine 110 having such a configuration can be constructed of, for example, a general computer.

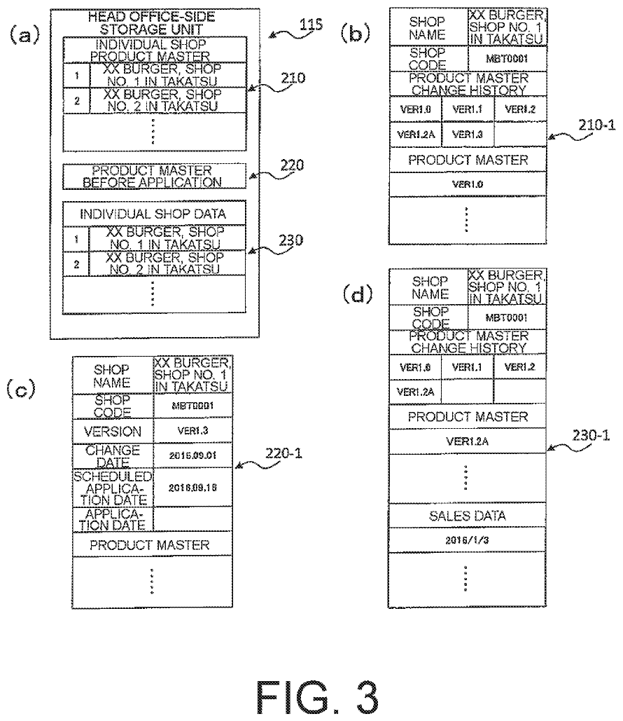

FIG. 3 includes conceptual diagrams for illustrating details of the head office-side storage unit 115. Specifically, FIG. 3 (a) is an illustration of details of the head office-side storage unit 115, FIG. 3 (b) is an illustration of details of individual shop product master data, FIG. 3 (c) is an illustration of details of the product master data before application, and FIG. 3 (d) is an illustration of details of the individual shop data.

Referring to FIG. 3 (a), a description is given of data held by the head office-side storage unit 115. As illustrated in FIG. 3 (a), the head office-side storage unit 115 includes an individual shop product master area 210, a product-master-before-application area 220, and an individual shop data area 230. Herein, the product-master-before-application area 220 may be referred to as “head-office-master-before-application area”. Further, each of the individual shop product master area 210, the product-master-before-application area 220, and the individual shop data area 230 may be stored in an external storage unit (not shown) provided outside the head office-side control unit 114. The individual shop product master area 210 includes, for each shop, the product master data of every shop connected to the head office machine 110 via the network as the individual shop product master data. The product-master-before-application area 220 includes, for each shop separately, the product master data before application of every shop connected to the head office machine 110 via the network, as product master data before being applied. The individual shop data area 230 includes, for each shop, the individual shop data of every shop connected to the head office machine 110 via the network.

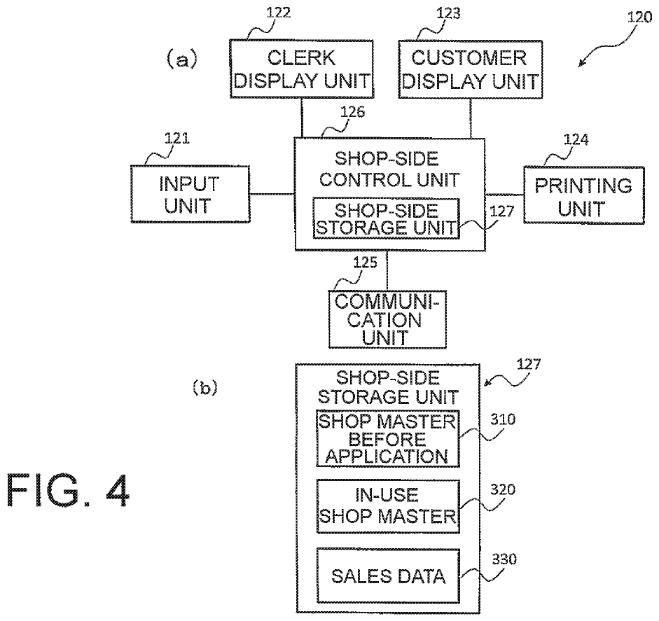

Referring to FIG. 3 (b), a description is given of the individual shop product master data. In FIG. 3 (b), individual shop product master data 210-1 of “XX Burger, Shop No. 1 in Takatsu” (hereinafter referred to as “shop No. 1”) is illustrated as an example of the individual shop product master data. The following description assumes that a shop machine installed at the shop No. 1 is the shop machine 120 described later (see FIG. 4).

The individual shop product master data 210-1 includes a shop name, a shop code, product master change histories, and product master data of each version number. The product master change histories include histories of changes of the product master data that have been applied to the shop machine 120 from the past to the present. Specifically, the product master change histories of the individual shop product master data 210-1 include, as the change histories, “VER 1.0”, “VER 1.1”, “VER 1.2”, “VER 1.2A”, and “VER 1.3”. Herein, a history indicated by “VER (number).(number)” means a change history of product master data on which maintenance has been performed by the head office machine 110. That is, of the product master change histories of the individual shop product master data 210-1, “VER 1.0”, “VER 1.1”, “VER 1.2”, and “VER 1.3” are change histories of product master data on which maintenance has been performed by the head office machine 110. Further, the history indicated by “VER (number).(number)(alphabet letter)” means a change history of product master data on which maintenance has been performed by the shop machine 120. That is, of the product master change histories of the individual shop product master data 210-1, “VER 1.2A” is a change history of product master data on which maintenance has been performed by the shop machine 120. Therefore, each of the head office machine 110 and the shop machine 120 can identify, based on whether or not “VER (number).(number)(alphabet letter)” written in the product master change history includes an alphabet letter, which of the head office machine 110 and the shop machine 120 has performed maintenance on relevant product master data. The individual shop product master data that is not applied to the shop machine 120 is the head office master data before application described above.

Referring to FIG. 3 (c), a description is given of the product master data before application. In FIG. 3 (c), product master data before application 220-1 of the shop No. 1 is illustrated as an example of the product master data before application. The product master data before application 220-1 is product master data on which maintenance has been performed in the head office machine 110 and before being applied to the shop machine 120.

The product master data before application 220-1 includes a shop name, a shop code, a version, a change date, a scheduled application date, an application date, and product master data. Herein, the change date means a date on which maintenance is performed on product master data included in individual shop data 230-1 described later in the head office machine 110. Further, the scheduled application date means a date on which application of the product master data before application 220-1 is scheduled to be started in the shop machine 120 (date on which use of the product master data is scheduled to be started). Still further, the application date means a date on which the product master data before application 220-1 is put into a state in which the product master data can be actually applied to (used in) the shop machine 120. The product master data before application is the head office master data before application described above.

Referring to FIG. 3 (d), a description is given of the individual shop data. In FIG. 3 (d), the individual shop data 230-1 of the shop No. 1 is illustrated as an example of the individual shop data.

The individual shop data 230-1 includes a shop name, a shop code, a product master change history, product master data, and sales data. The product master data of the individual shop data 230-1 is the head office master data described above. The individual shop data 230-1 includes the sales data, but is not always required to include the sales data.

Next, referring to FIG. 4, a description is given of a configuration of the shop machine of the POS system according to the first example embodiment. FIG. 4 (a) is a block diagram for illustrating the configuration of the shop machine, and FIG. 4 (b) is a block diagram for illustrating data held by the shop-side storage unit included in the shop machine.

In the first example embodiment, the shop machine 120 is constructed of one POS terminal device. Specifically, as illustrated in FIG. 4 (a), the shop machine 120 includes an input unit 121 configured to receive input of data and the like, a clerk display unit 122 and a customer display unit 123 each configured to display a result of information processing and the like, a printing unit 124 configured to print a receipt and the like, a communication unit 125 configured to communicate to/from other apparatus, and a shop-side control unit 126, which includes a shop-side storage unit 127 configured to store an application program and the like, and is configured to perform overall control of the shop machine 120. The shop machine 120 having such a configuration can be constructed of, for example, a general computer. The first shop machine 120-1 to the N-th shop machine 120-N illustrated in FIG. 1 each have the same configuration as that of the shop machine 120. The shop machine 120 is not always required to include the customer display unit 123.

Next, referring to FIG. 4 (b), a description is given of the shop-side storage unit 127. FIG. 4 (b) is an illustration of details of the shop-side storage unit 127. The shop-side storage unit 127 includes a shop-master-before-application area 310, an in-use shop master area 320, and a sales data area 330. In the shop-master-before-application area 310, product master data on which maintenance has been performed in the head office machine 110 or the shop machine 120 and before being actually used in the shop machine 120 is stored. The product master data stored in the shop-master-before-application area 310 is the shop master data before application described above. In the in-use shop master area 320, product master data currently used by the shop machine 120 is stored. The product master data stored in the in-use shop master area 320 is the in-use shop master data described above. In the sales data area 330, sales data, which is records of sales of products, is stored. The shop-master-before-application area 310, the in-use shop master area 320, and the sales data area 330 may be stored in an external storage unit (not shown) provided outside the shop-side control unit 126. The shop-side storage unit 127 may also hold past product master data.

[Processing to be Executed when Maintenance is Performed on Product Master Data in Head Office Machine]

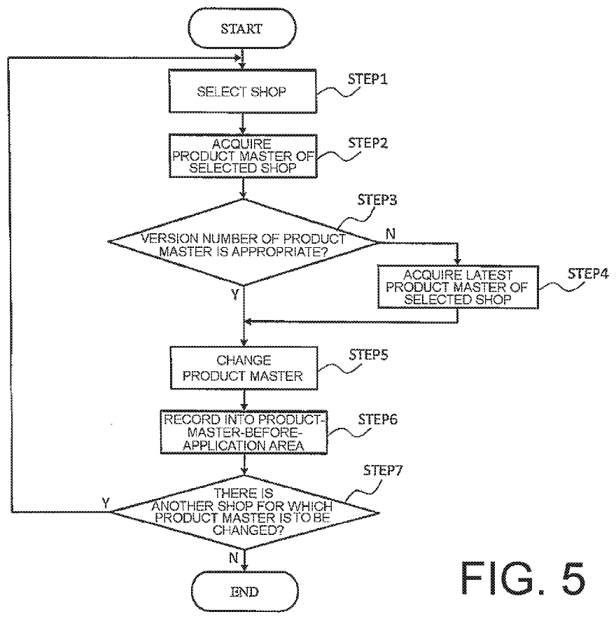

Referring to FIG. 5, a description is given of a flow of processing to be executed by the head office-side control unit 114 of the head office machine 110 when maintenance is performed on the product master data. FIG. 5 is a flowchart for illustrating the flow of the processing by the head office-side control unit 114.

First, when the head office-side control unit 114 has received, from a person in charge of maintenance in a head office, input of giving an instruction to start an application program for performing maintenance on the product master data, the head office-side control unit 114 starts the application program. After the application program is started, a shop for which maintenance on the product master data is to be performed (e.g., shop No. 1) is selected based on input from the person in charge of maintenance in the head office (STEP 1).

Next, the head office-side control unit 114 acquires, from the individual shop data area 230 (see FIG. 3 (a)), the individual shop data 230-1 (see FIG. 3 (d)) of the selected shop (STEP 2).

Next, the head office-side control unit 114 determines whether or not a version number of the product master data included in the acquired individual shop data 230-1 is appropriate (STEP 3). That “version number of product master data is appropriate” means that the version number of the acquired product master data and the latest version number of the individual shop product master data are the same. That “version number of product master data is not appropriate” means that the version number of the acquired product master data and the latest version number of the individual shop product master data are not the same.

Now, referring again to FIG. 3, a description is given of specific processing in which the head office-side control unit 114 determines the version number of the product master data.

In FIG. 3 (b), there is illustrated a state in which the product master change histories include “VER 1.3” after maintenance is performed on the individual shop data 230-1 illustrated in FIG. 3 (d) in the head office machine 110. In this case, at the time of performing maintenance in the head office machine 110, when the head office-side control unit 114 acquires the individual shop data 230-1 from the head office-side storage unit 117, the version number of the product master data included in the individual shop data 230-1 is “VER 1.2A” (see FIG. 3 (d)). At this time, as illustrated in FIG. 3 (b) and FIG. 3 (c), the version number of the individual shop product master data 210-1 is “VER 1.2A” because “VER 1.3” is yet to be applied. That is, the version number of the acquired product master data and the latest version number of the product master data contained in the individual shop data match each other. In such a case, the head office-side control unit 114 determines that the version number of the acquired product master data is appropriate.

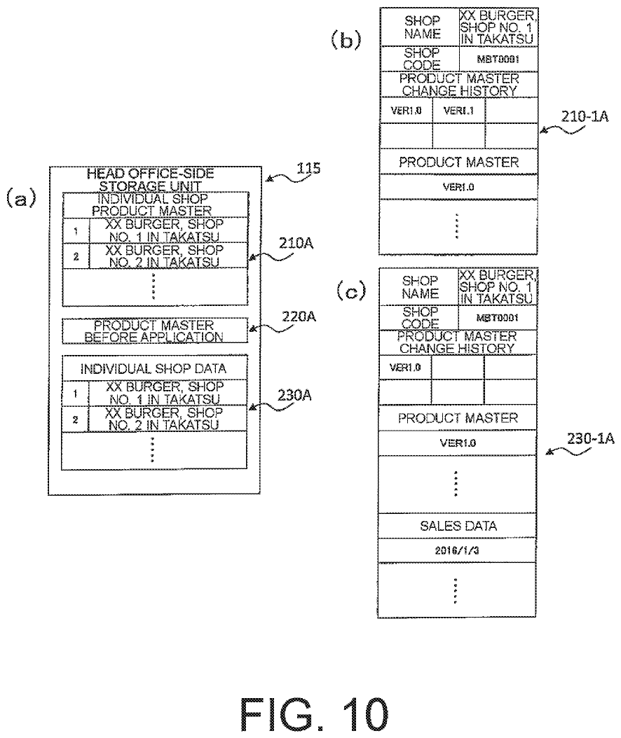

When it is determined in STEP 3 that the version number of the product master data is not appropriate (“N” in STEP 3), the head office-side control unit 114 acquires from the head office-side storage unit 115 the latest product master data of the shop selected in STEP 1 (STEP 4). Now, referring to FIG. 10, a description is given of processing in which the head office-side control unit 114 acquires the latest product master data of the selected shop.

FIG. 10 are illustrations of the product master data of the shop No. 1 before maintenance is performed in the head office machine 110. Specifically. FIG. 10 (a) is an illustration of details of the head office-side storage unit 115, FIG. 10 (b) is an illustration of details of the individual shop product master data of the shop No. 1, and FIG. 10 (c) is an illustration of details of the individual shop data of the shop No. 1. As illustrated in FIG. 10 (a), the head office-side storage unit 115 includes an individual shop product master area 210A, a product-master-before-application area 220A, and an individual shop data area 230A. Referring to FIG. 10 (b), the version number of individual shop product master data 210-1A is “VER 1.1”. Referring to FIG. 10 (c), the version number of the product master data included in individual shop data 230-1A is “VER 1.0”. That is, in FIG. 10 (b) and FIG. 10 (c), there is illustrated a state in which the version number of the product master data currently used by the shop machine No. 1 is older than the version number of the individual shop product master data 210-1A held by the head office machine 110. Such a state occurs when the individual shop product master data 210-1A of “VER 1.1” has not been applied due to a failure or the like of the shop machine 120. In this case, the head office-side control unit 114 acquires from the head office-side storage unit 115 the individual shop product master data 210-1A of “VER 1.1”, which is the latest version number of the individual shop product master data.

When the version number of the product master data is appropriate in STEP 3 (“Y” in STEP 3) and when the head office-side control unit 114 acquires the latest product master data in STEP 4, the person in charge of maintenance in the head office changes (performs maintenance on) the product master data, and specifies the scheduled application date (STEP 5). That is, the head office-side control unit 114 confirms whether the product master data currently used by the shop machine 120 is not product master data that has been subjected to maintenance last time in the head office machine 120, or is not product master data that has been further subjected to maintenance in the shop machine 110 after being subjected to maintenance in the head office machine 120. Then, the head office-side control unit 114 acquires from the head office-side storage unit 115 the latest product master data (product master data that has been subjected to maintenance last time in the head office machine 110), and performs maintenance on the acquired product master data. At this time, the head office-side control unit 114 performs maintenance on the product master data for the shop machine 120 in accordance with the person in charge of maintenance in the head office. Further, the head office-side control unit 114 counts the number of times of maintenance, and, for example, when the number of times of maintenance has reached a predetermined value (e.g., 50) or larger, of the two numbers included in “VER (number).(number)”, the head office-side control unit 114 adds 1 to the first number and returns the second number to 0. Meanwhile, when the number of times of maintenance is smaller than the predetermined value (e.g., 50), of the two numbers included in “VER (number).(number)”, the head office-side control unit 114 does not change the first number, and adds 1 to the second number. Further, when the version number is “VER (number).(number)(alphabet letter)”, the head office-side control unit 114 deletes the alphabet letter. Further, at the time of maintenance, the product master data is yet to be applied, and hence the application date field is set blank.

Next, the head office-side control unit 114 stores the product master data after being subjected to maintenance into the product-master-before-application area 220. At this time, the head office-side control unit 114 stores the product master data after being subjected to maintenance also into the individual shop product master area 210, and records the product master data into the change history (STEP 6).

Next, the head office-side control unit 114 determines whether or not there is input of another shop for which the product master data is to be changed (STEP 7). When there is another shop for which the product master data is to be changed (“Y” in STEP 7), the head office-side control unit 114 returns to STEP 1 to execute the processing of from STEP 1 to STEP 7 on the shop. Then, when there is no shop for which the product master data is to be changed (“Y” in STEP 7), the head office-side control unit 114 ends the processing (“N” in STEP 7).

[Processing to be Executed when Product Master Data Held by Head Office Machine is Loaded in Shop Machine]

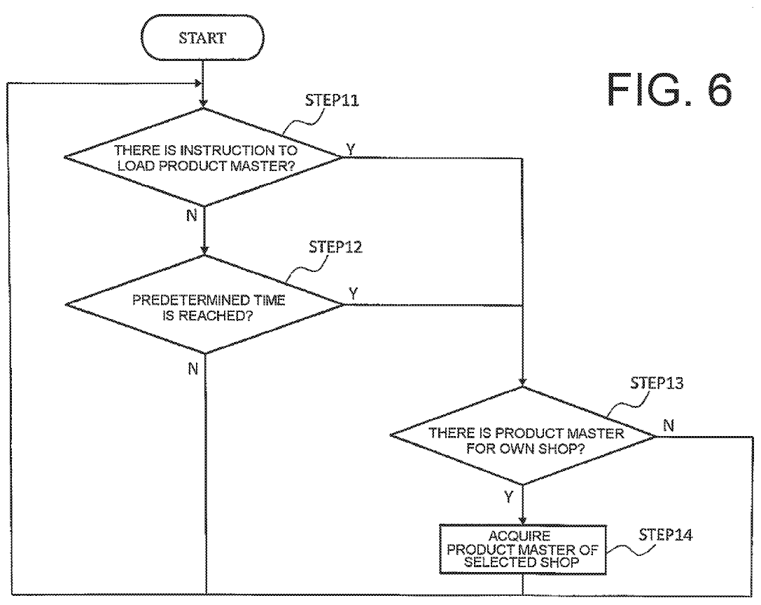

Referring to FIG. 6, a description is given of processing to be executed by the shop-side control unit 126 of the shop machine 120 when the product master data before application 220-1 held by the product-master-before-application area 220 of the head office machine 110 is loaded in the shop machine 120.

The shop-side control unit 126 confirms whether or not there is input of giving an instruction to load the product master data before application 220-1 (STEP 11).

When there is no input of giving an instruction to load the product master data before application 220-1 (“N” in STEP 11), the shop-side control unit 126 determines whether or not a current time is a predetermined time defined in advance (STEP 12). In this case, the predetermined time is, for example, every hour within business hours of the shop. Further, the predetermined time is not particularly limited, and a user or the like can freely set the predetermined time.

When the current time is not the predetermined time defined in advance (“N” in STEP 12), the shop-side control unit 126 returns to STEP 11.

When there is input of giving an instruction to load the product master data before application 220-1 in STEP 11 (“Y” in STEP 11), the shop-side control unit 126 determines whether or not the product-master-before-application area 220 includes the product master data before application 220-1 of the own shop (shop No. 1) (STEP 13). Further, also when the current time is the predetermined time defined in advance in STEP 12 (“Y” in STEP 12), the shop-side control unit 126 proceeds to STEP 13.

When it is determined in STEP 13 that the product-master-before-application area 220 does not include the product master data before application 220-1 (“N” in STEP 13), the shop-side control unit 126 returns to STEP 11.

When it is determined in STEP 13 that the product-master-before-application area 220 includes the product master data before application 220-1 (“Y” in STEP 13), the shop-side control unit 126 loads the product master data before application 220-1, and stores the acquired product master data before application 220-1 into the shop-master-before-application area 310 (see FIG. 4 (b)) of the shop-side storage unit 127 as the shop master data before application (STEP 14). Further, when the shop-side control unit 126 loads the product master data before application 220-1, the shop-side control unit 126 checks the version number (VER) to load only the product master data before application of the version number (VER) that has not been loaded yet.

Then, the shop-side control unit 126 returns to STEP 11.

[Processing to be Executed when Maintenance is Performed on Product Master Data in Shop Machine]

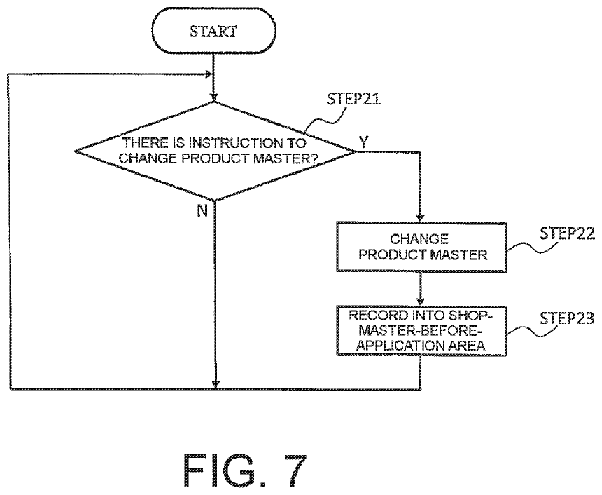

Referring to FIG. 7, a description is given of processing of changing the product master data currently applied in the shop machine 120, that is, processing to be executed by the shop-side control unit 126 of the shop machine 120 when maintenance is performed.

First, the shop-side control unit 126 confirms whether or not there is input of giving an instruction to change the product master data currently used from a person in charge of maintenance in a shop (STEP 21).

Next, when there is no input of giving an instruction to change the product master data in STEP 21 (“N” in STEP 21), the shop-side control unit 126 returns to STEP 21 to repeat the processing of STEP 21. When there is input of giving an instruction to change the product master data in STEP 21 (“Y” in STEP 21), the shop-side control unit 126 changes (performs maintenance on) the product master data currently used in accordance with input of the person in charge of maintenance in the shop (STEP 22). At this time, the shop-side control unit 126 inputs the scheduled application date, and sets the application date field blank (see FIG. 3 (c)). Further, when the version number of the product master data before change is “VER (number).(number)”, after the maintenance, the shop-side control unit 126 does not change the two numbers, and adds an alphabet letter to the end as in “VER (number).(number)A”. Further, when the version number of the product master data before change is “VER (number).(number)(alphabet letter)”, the shop-side control unit 126 updates the alphabet letter at the end to the next letter in the alphabetical order. Specifically, when the version number of the product master data before maintenance is “VER (number).(number)A”, after the maintenance, the shop-side control unit 126 updates the version number to “VER (number).(number)B”.

Next, the shop-side control unit 126 stores the changed product master data into the shop-master-before-application area 310 as the shop master data before application (STEP 23). Then, the shop-side control unit 126 returns to STEP 21.

[Processing to be Executed when Shop Master Data Before Application is Applied in Shop Machine]

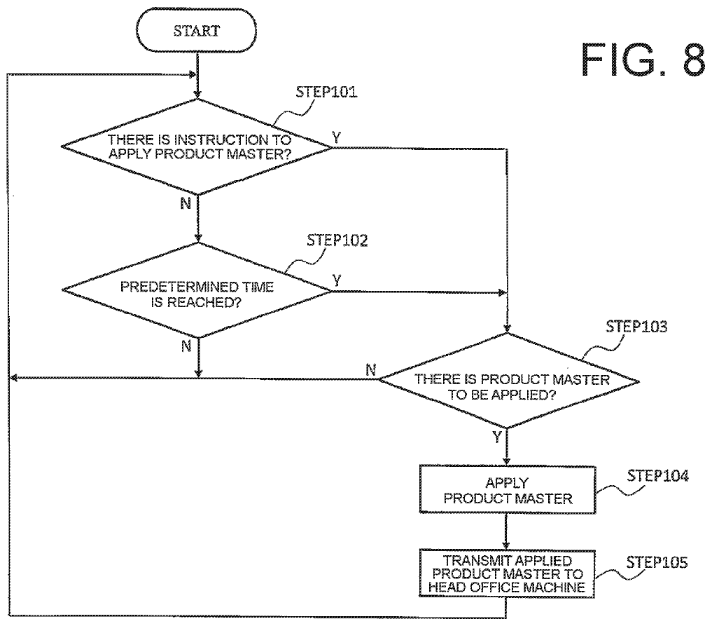

Referring to FIG. 8, a description is given of processing to be executed by the shop-side control unit 126 until the shop master data before application in the shop-master-before-application area 310 is brought into an in-use state in the shop machine 120 in place of the product master data currently used. In the following, bringing the shop master data before application into the in-use state in place of the product master data currently used may be referred to simply as “application of product master data”.

First, the shop-side control unit 126 confirms whether or not there is input of giving an instruction to apply the shop master data before application (STEP 101).

Next, when there is no input of giving an instruction to apply the shop master data before application in STEP 101 (“N” in STEP 101), the shop-side control unit 126 determines whether or not a current time is a predetermined time defined in advance (STEP 102). In this case, the predetermined time is, for example, a time one hour before an opening time or a time 30 minutes after a closing time. That is, the predetermined time means a time at which a shop at which the shop machine 120 is installed is not opened. The user or the like can freely set the predetermined time. Then, when it is determined in STEP 102 that the current time is not the predetermined time (“N” in STEP 102), the shop-side control unit 126 returns to STEP 101.

When there is input of giving an instruction to apply the shop master data in STEP 101 (“Y” in STEP 101), the shop-side control unit 126 determines whether or not the shop-master-before-application area 310 includes product master data to be applied (STEP 103). Further, also when it is determined in STEP 102 that the current time is the predetermined time (“Y” in STEP 102), the shop-side control unit 126 proceeds to STEP 103. In this case, for example, when the time at the execution of STEP 103 is before the opening time, the product master data to be applied is product master data in which the scheduled application date is the current day and the application date field is blank. Meanwhile, when the time at the execution of STEP 103 is after the closing time, the product master data to be applied is product master data in which the scheduled application date is the next day and the application date field is blank. Further, when the time at the execution of STEP 103 is within the business hours (between the opening time and the closing time), the product master data to be applied is product master data in which the scheduled application date is the current day and the application date field is blank. As another example, there may be added a step of determining, by the shop-side control unit 126, whether or not there is input of an instruction to apply only the product master data in which the scheduled application date is the current day when the time at the execution of STEP 103 is within the business hours (between the opening time and the closing time). In this case, the shop-side control unit 126 may determine that there is product master data to be applied only when it is determined that there is input of an instruction to apply the product master data.

Next, when it is determined in STEP 103 that the shop-master-before-application area 310 does not include product master data to be applied (shop master data before application) (“N” in STEP 103), the shop-side control unit 126 returns to STEP 101.

When it is determined in STEP 103 that the shop-master-before-application area 310 includes product master data to be applied (shop master data before application) (“Y” in STEP 103), the shop-side control unit 126 applies the product master data (shop master data before application) in place of the product master data currently used (STEP 104). That is, the shop-side control unit 126 deletes the product master data currently used, and copies the product master data to be applied to the in-use shop master area 320. At this time, the shop-side control unit 126 stores a date on which the product master data is applied into the product master data as the application date. After that, the shop-side control unit 126 deletes the applied product master data (shop master data before application) from the shop-master-before-application area 310. Further, when there are a plurality of pieces of product master data in which the scheduled application date is the same and the application date field is blank, the shop-side control unit 126 applies the pieces of product master data in ascending order of the version number in place of the product master data currently used. Still further, when there are a plurality of pieces of product master data in which the scheduled application date is over or the application date field is blank and the product master data is yet to be applied, the shop-side control unit 126 applies the pieces of product master data in ascending order of date in place of the product master data currently used.

Next, the shop-side control unit 126 transmits the applied product master data to the head office machine 110 (STEP 105). Then, the shop-side control unit 126 returns to STEP 101.

[Processing to be Executed when Product Master Data has been Received from Shop Machine in Head Office Machine]

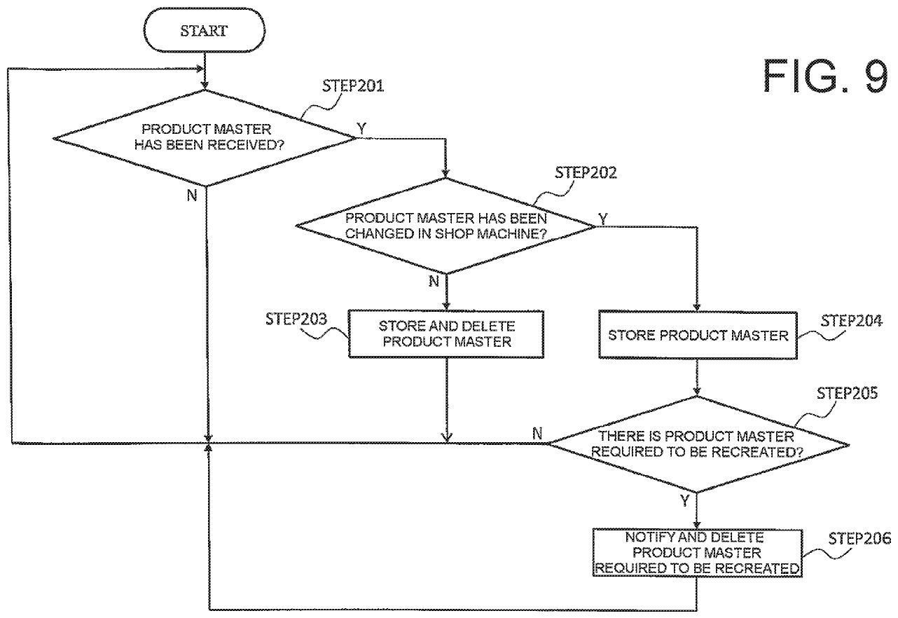

Referring to FIG. 9, a description is given of processing to be executed by the control unit of the head office machine 110 when the applied product master data (in-use shop master data) has been received from the shop machine 120.

First, the head office-side control unit 114 confirms whether or not the applied product master data transmitted from the shop machine 120 has been received (STEP 201).

Next, when the head office-side control unit 114 has failed to confirm the reception of the applied product master data in STEP 201 (“N” in STEP 201), the head office-side control unit 114 returns to STEP 201 to repeat the processing of STEP 201. Meanwhile, when the head office-side control unit 114 has successfully confirmed the reception of the individual shop data 230-1 including the product master data in STEP 201 (“Y” in STEP 201), the head office-side control unit 114 determines whether or not the received product master data is product master data that has been changed in the shop machine 120 (STEP 202).

Next, when it is determined in STEP 202 that the received product master data is not the product master data that has been changed in the shop machine 120 (“N” in STEP 202), the head office-side control unit 114 stores the product master data into the individual shop data area 230, and deletes the corresponding product master data before application 220-1 (STEP 203). In this case, after the head office-side control unit 114 deletes the product master data before application 220-1, the head office-side control unit 114 returns to STEP 201.

Meanwhile, when it is determined in STEP 202 that the received product master data of the individual shop data 230-1 is the product master data that has been changed in the shop machine 120 (“Y” in STEP 202), the head office-side control unit 114 stores the received product master data into the product master data of the individual shop data area 230 of the shop that has transmitted the product master data (STEP 204). At this time, the head office-side control unit 114 stores the received product master data also into the individual shop product master area 210, and adds the relevant version number to the product master change history.

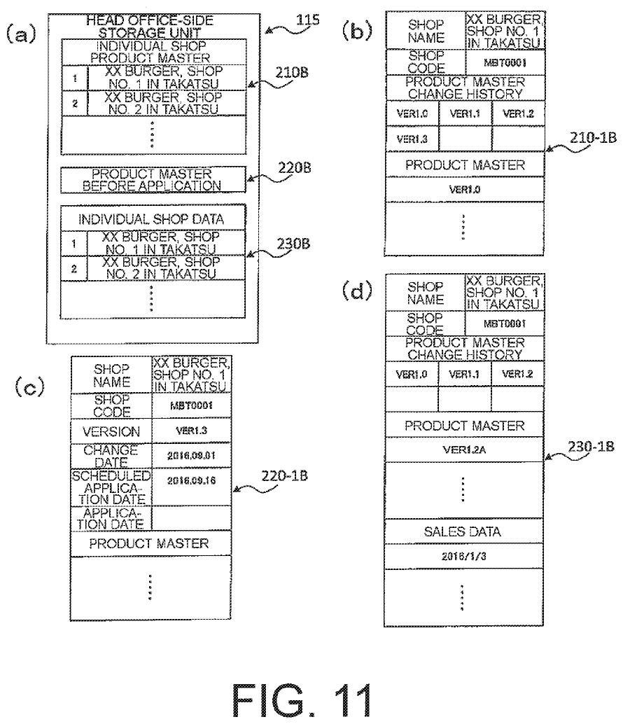

Next, the head office-side control unit 114 determines whether or not there is product master data required to be recreated among pieces of product master data before application held in the product-master-before-application area 220 held by the head office-side storage unit 115 (STEP 205). In this case, the case in which there is product master data required to be recreated corresponds to a case in which, for example, product master data having the version number later than the version number before change of the received product master data is stored in the product-master-before-application area. Referring to FIG. 11, a specific description is given of the product master data required to be recreated.

FIG. 11 are illustrations of a state after maintenance has been performed on the product master data of the shop No. 1 in the head office machine 110. Specifically, FIG. 11 (a) is an illustration of details of the head office-side storage unit 115 of the head office machine 110, FIG. 11 (b) is an illustration of the product master data after being subjected to maintenance in the head office machine 110, FIG. 11 (c) is an illustration of the product master data before application after being subjected to maintenance in the head office machine 110, and FIG. 11 (d) is an illustration of the individual shop data after being subjected to maintenance in the head office machine 110. As illustrated in FIG. 11 (a), the head office-side storage unit 115 includes an individual shop product master area 210B, a product-master-before-application area 220B, and an individual shop data area 230B.

As illustrated in FIG. 11 (b), referring to change histories of individual shop data 230-1B, the version number next to “VER 1.2” is “VER 1.3”. Further, FIG. 11 (c) is an illustration of product master data before application 220-1B of “VER 1.3”. That is, the product master data before application 220-1B is the product master data created based on the product master data of “VER 1.2”.

Referring to the individual shop data 230-1B illustrated in FIG. 11 (d), the version number of the individual shop data 230-1B is “VER 1.2A”. The product master data of “VER 1.2A” is product master data obtained after the shop machine 120 has performed maintenance on the product master data of “VER 1.2”. In this case, when the shop machine 120 has transmitted the product master data of “VER 1.2A” to the head office machine 110, the product master data of “VER 1.3” is product master data required to be recreated. That is, the product master data before application 220-1B of “VER 1.3” has been created based on the product master data of “VER 1.2”, and hence the head office-side control unit 114 determines that it is required to recreate product master data that is based on “VER 1.2A”, which has been created between “VER 1.2” and “VER 1.3”.

Referring again to FIG. 9, when it is determined next in STEP 205 that there is no product master data required to be recreated (“N” in STEP 205), the head office-side control unit 114 returns to STEP 201.

Meanwhile, when it is determined in STEP 205 that there is product master data required to be recreated (“Y” in STEP 205), the head office-side control unit 114 gives a notification that there is product master data required to be recreated, and deletes the product master data required to be recreated (STEP 206). Then, the head office-side control unit 114 returns to STEP 201.

Now, referring again to FIG. 11, as an example of notification and deletion of the product master data required to be recreated, a description is given of an example of processing to be executed when, because the head office machine 110 has received the product master data of “VER 1.2A”, the product master data to replace “VER 1.3” created based on the product master data of “VER 1.2” is to be recreated.

First, when the head office-side control unit 114 has received the product master data of “VER 1.2A”, the head office-side control unit 114 displays on the display unit 112 a message to the effect that the product master data of “VER 1.3” is required to be recreated. Next, the head office-side control unit 114 deletes the product master data of “VER 1.3” included in the individual shop product master data 210-1B, and deletes “VER 1.3” also from the product master change history. Further, the head office-side control unit 114 also deletes the product master data of “VER 1.3” included in the product master data before application 220-1B. Still further, the product master data of “VER 1.3” may have already been loaded into the shop machine 120, and hence the head office-side control unit 114 instructs the shop machine 120 to delete the product master data of “VER 1.3”. In this case, when the shop machine 120 has received the instruction, in a case where the shop-master-before-application area 310 (see FIG. 4 (b)) includes the product master data of “VER 1.3”, the shop machine 120 deletes the product master data.

For the sales data included in the individual shop data 230-1B of the head office machine 110, sales data may be transmitted every time a sale of a product to a customer is finished in the shop machine 120, or records of product sales until the predetermined time may be collectively transmitted as sales data when a predetermined time defined in advance is reached.

As described above, according to the first example embodiment, when maintenance is to be performed on the master data in the head office machine 110, the maintenance can be performed without collecting the product master data from the shop machine 120. In addition, when the shop machine 120 is to be replaced due to a failure or other such reasons, a newly installed shop machine loads product master data from the head office machine 110, to thereby be able to acquire the product master data that has been in the application state immediately before the replacement. Therefore, in the first example embodiment, a shop machine can easily be replaced.

### Second Example Embodiment

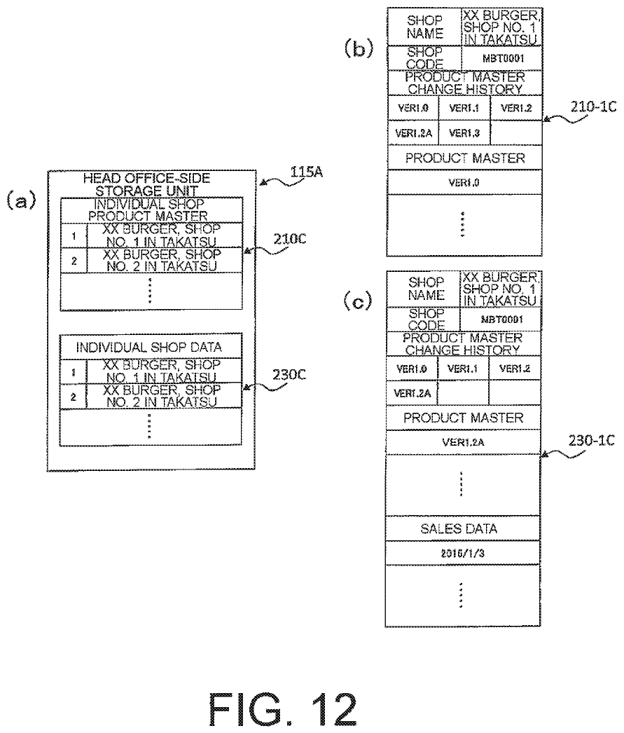

A second example embodiment will be described with reference to FIG. 12 to FIG. 14.

A POS system according to the second example embodiment differs from the POS system according to the first example embodiment in the following points, and other configurations of the second example embodiment are the same as those of the first example embodiment.

A first difference is that, in the second example embodiment, a head office-side storage unit 115A does not hold the product master data before application.

Referring to FIG. 12, a description is given of details of the head office-side storage unit 115A in the second example embodiment.

FIG. 12 includes illustrations of details of the head office-side storage unit 115A of the head office machine 110. FIG. 12 (a) is an illustration of details of the head office-side storage unit 115A, FIG. 12 (b) is an illustration of the individual shop product master data, and FIG. 12 (c) is an illustration of the individual shop data. As illustrated in FIG. 12 (a), the head office-side storage unit 115A of the head office machine 110 includes an individual shop product master area 210C and an individual shop data area 230C. That is, the head office-side storage unit 115A does not include a product-master-before-application area in which the product master data before application is stored.

A second difference is that, when the shop machine 120 has received the product master data that has been subjected to maintenance from the head office machine 110, the shop machine 120 stores the product master data into the shop-master-before-application area 310. As a result, the shop machine 120 does not perform the processing (see FIG. 6) of loading the product master data before application included in the product-master-before-application 220 of the head office machine 1100.

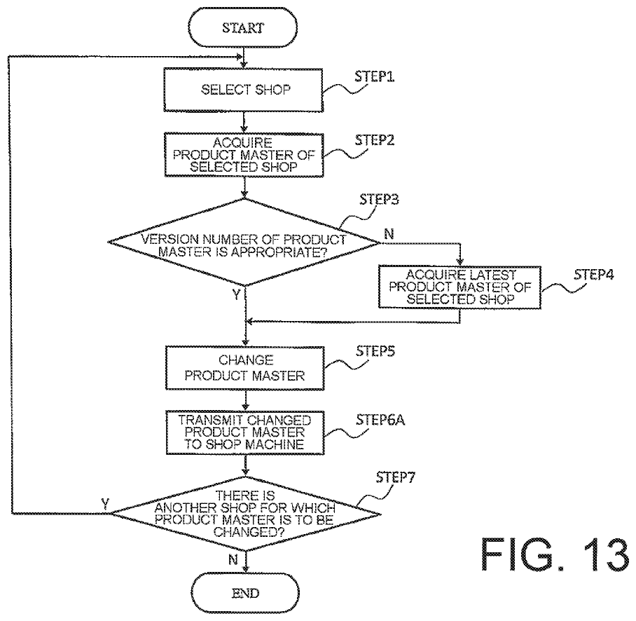

Referring to FIG. 13, a description is given of a flow of processing to be executed by the head office-side control unit 114 of the head office machine 110 when maintenance is performed on the product master data in the head office machine 110. FIG. 13 is a flowchart for illustrating the processing to be executed by the head office-side control unit 114 of the head office machine 110 when maintenance is performed on the product master data in the head office machine 110. The flowchart illustrated in FIG. 13 differs from the flowchart illustrated in FIG. 5 only in processing of STEP 6A. Thus, in the following, only STEP 6A is described, and a description of the other steps is omitted.

In STEP 6A, the head office-side control unit 114 transmits the product master data that has been subjected to maintenance to the shop machine 120, and records the product master data into product master data included in individual shop product master data 210-1C and further records the relevant version number into the product master change history. When the shop-side control unit 116 of the shop machine 120 has received the product master data that has been subjected to maintenance, the shop-side control unit 116 stores the received product master data into the shop-master-before-application area 310.

A third difference is that, after the head office machine 110 has received applied product master data from the shop machine 120, it is not required to delete product master data before application corresponding to the applied product master data.

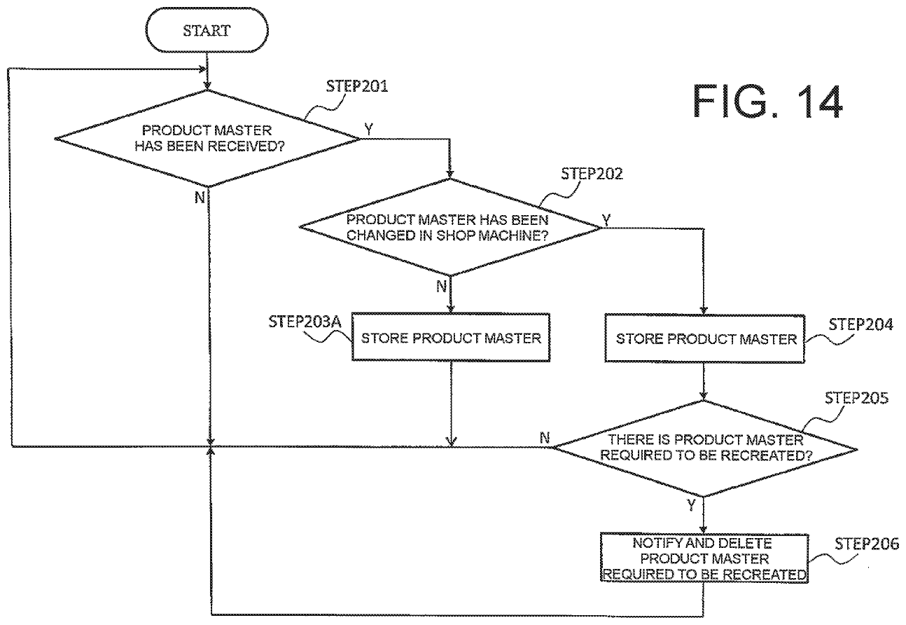

Referring to FIG. 14, a description is given of a flow of processing to be executed by the head office-side control unit 114 of the head office machine 110 when the product master data has been received from the shop machine 120. FIG. 14 is a flowchart for illustrating the flow of processing to be executed by the head office-side control unit 114 of the head office machine 110 when the applied product master data has been received from the shop machine 120. The flowchart illustrated in FIG. 14 differs from the flowchart illustrated in FIG. 9 only in processing of STEP 203A. Thus, in the following, only STEP 203A is described below, and a description of the other steps is omitted.

In STEP 2034, the head office-side control unit 114 stores the applied product master data received from the shop machine 120 into individual shop data 230-1C. The head office-side storage unit 115A does not include the product-master-before-application area, and is thus not required to delete the product master data before application corresponding to the received product master data.

In the second example embodiment also, when maintenance is to be performed on the master data in the head office machine 110, the maintenance can be performed without collecting the master data from the shop machine 120. In addition, in the second example embodiment also, when the shop machine 120 is to be replaced due to a failure or other such reasons, a newly installed shop machine loads the master data from the head office machine 110, to thereby be able to acquire the master data that has been in the application state. Therefore, in the second example embodiment also, a shop machine 120 can easily be replaced.

### MODIFICATION EXAMPLES OF FIRST EXAMPLE AND SECOND EXAMPLE EMBODIMENTS

### Modification Example 1

In the first example embodiment and the second example embodiment, the master data includes only the product master data. However, the master data may also include other master data, which is, for example, master data required for the operation of a shop, such as master data on ingredients of a product and master data on equipment of the shop.

### Modification Example 2

In the first example embodiment and the second example embodiment, the head office machine 110 is constructed of one information processing device being a computer. However, the head office machine 110 may be a combination of a plurality of devices as long as equivalent functions are implemented.

### Modification Example 3

In the first example embodiment and the second example embodiment, the shop machine 120 is constructed of one POS terminal device being a computer. However, the shop machine 120 may include the POS terminal device according to each of the above-mentioned example embodiments as a parent device and a plurality of POS terminal devices being child devices connected to the parent device in a manner that enables data communication to/from the parent device, as long as equivalent functions are implemented. In this case, the POS terminal device being the parent device instructs the plurality of POS terminal devices being the child devices to, for example, change the product master data.

Further, the shop machine 120 may include one shop server and a plurality of POS terminal devices connected to the one shop server in a manner that enables data communication to/from the shop server. In this case, the shop server has the same functions as those of the POS terminal device according to each of the above-mentioned example embodiments, and the shop server instructs the plurality of POS terminal devices to, for example, change the product master data.

### Other Example Embodiments

In the POS system 1, the head office machine 110 and the shop machine 120 may be implemented by hardware, or may be implemented by software. Further, the head office machine 110 and the shop machine 120 may be implemented by a combination of hardware and software.

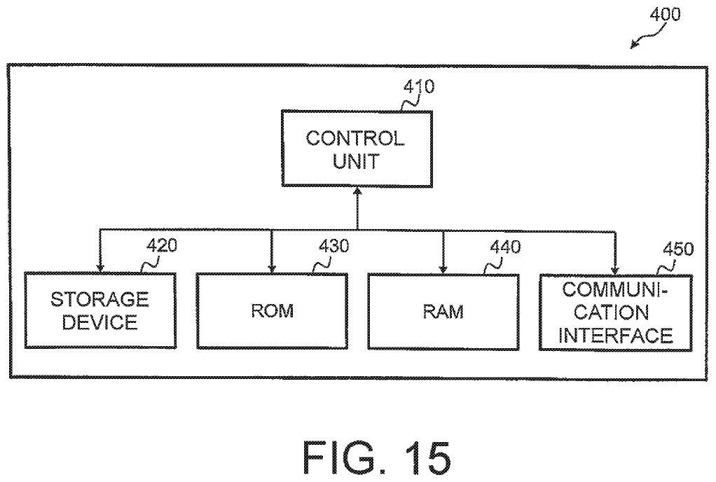

FIG. 15 is an illustration of an example of the information processing device (computer) for constructing each of the head office machine 110 and the shop machine 120.

As illustrated in FIG. 15, an information processing device 400 includes a control unit 410, a storage device 420, a ROM (Read Only Memory) 430, a RAM (Random Access Memory) 440, and a communication interface 450.

The control unit 410 can be constructed of an arithmetic processing device, for example, a CPU (Central Processing Unit). The control unit 410 loads a program readable by the control unit 410, which is held in the storage device 420 or the ROM 430, onto the RAM 440 and executes the program, to thereby be able to implement various functions of each of the head office machine 110 and the shop machine 120. Further, the control unit 410 may include an internal buffer capable of temporarily storing data and others.

The storage device 420 is a large-capacity storage medium capable of holding various types of data, and can be implemented by a storage medium such as a magneto-optical disk, a HDD (Hard Disk Drive), and a SSD (Solid State Drive). Further, when the information processing device 400 is connected to a communication network via the communication interface 450, the storage device 420 may be a cloud storage existing on the communication network. Further, the storage device 420 may hold a program that is readable by the control unit 410.

The ROM 430 is a non-volatile storage device, which has a capacity smaller than that of the storage device 420, and can be constructed of, for example, a flash memory. Further, the ROM 430 may hold a program that is readable by the control unit 410. The program that is readable by the control unit 410 is only required to be held by at least one of the storage device 420 or the ROM 430.

The RAM 440 is a semiconductor memory, for example, a DRAM (Dynamic Random Access Memory) or a SRAM (Static Random Access Memory), and can be used as an internal buffer for temporarily storing data and others.

The communication interface 450 is an interface for connecting the information processing device 400 to the communication network in a wired or wireless manner.

Part or whole of the above-mentioned example embodiments may also be described as the following supplementary notes. Note that, the following supplementary notes are not intended to limit this invention.

[Supplementary Note 1]

A POS system, comprising a shop machine installed in a shop and configured to perform processing related to a product sale, and a head office machine installed in a head office, the shop machine and the head office machine being connected to each other via a network in a manner that enables data communication to/from each other, the POS system being capable of performing, in the head office machine and the shop machine, maintenance on master data to be used when the shop machine performs the processing related to the product sale,
wherein the head office machine includes:
   a head office-side control unit; and
   a head office-side storage unit configured to hold head office master data.
wherein the shop machine includes:
   a shop-side control unit; and
   a shop-side storage unit configured to hold in-use shop master data, which is currently used, and shop master data before application, which has been subjected to maintenance in the head office machine or the own shop machine,
wherein the shop-side control unit is configured to transmit the in-use shop master data to the head office machine when the shop master data before application is determined as being usable as the in-use shop master data, and
wherein the head office-side control unit is configured to store the in-use shop master data received from the shop machine into the head office-side storage unit as new head office master data.

[Supplementary Note 2]

The POS system according to Supplementary Note 1,
wherein the head office-side storage unit includes a head-office-master-before-application area configured to holding head office master data that has been subjected to maintenance in the head office machine, as head office master data before application, and
wherein the shop-side control unit is configured to store the head office master data before application, which has been stored into the head-office-master-before-application area, into the shop-side storage unit as the shop master data before application.

[Supplementary Note 3]

The POS system according to Supplementary Note 1,
wherein the head office-side control unit is configured to transmit head office master data that has been subjected to maintenance in the head office machine, to the shop machine as head office master data before application, and
wherein the shop-side control unit is configured to store the received head office master data before application into the shop-side storage unit as the shop master data before application.

[Supplementary Note 4]

The POS system according to any one of Supplementary Notes 1 to 3, wherein, before maintenance on the head office master data is performed, the head office-side control unit confirms whether the head office master data is head office master data that has been subjected to maintenance last time in the head office machine, or head office master data that has been further subjected to maintenance in the shop machine after being subjected to maintenance last time in the head office machine.

[Supplementary Note 5]

The POS system according to Supplementary Note 4, wherein, when the head office-side control unit has confirmed that the head office master data is not the head office master data that has been subjected to maintenance last time in the head office machine, or the head office master data that has been further subjected to maintenance in the shop machine after being subjected to maintenance last time in the head office machine, the head office-side control unit performs maintenance on the head office master data that has been subjected to maintenance last time in the head office machine.

[Supplementary Note 6]

The POS system according to any one of Supplementary Notes 1 to 5, wherein the head office-side control unit is allowed to identify whether the head office master data is head office master data that has been subjected to maintenance in the head office machine, or head office master data that has been subjected to maintenance in the shop machine.

[Supplementary Note 7]

A master data maintenance method, which is executed in a configuration in which a shop machine installed in a shop and configured to perform processing related to a product sale and a head office machine installed in a head office are connected to each other via a network in a manner that enables data communication to/from each other and, in the head office machine and the shop machine, maintenance is performed on master data to be used when the shop machine performs the processing related to the product sale,
the master data maintenance method comprising the steps of:
   transmitting, by the shop machine, when shop master data before application that has been subjected to maintenance in the head office machine or the own shop machine is determined as being usable in the own shop machine as in-use shop master data, the in-use shop master data to the head office machine; and
   storing, by the head office machine, the received in-use shop master data into a head office-side storage unit as new head office master data.

[Supplementary Note 8]

The master data maintenance method according to Supplementary Note 7, further comprising a step of storing, by the shop machine, the head office master data that has been subjected to maintenance in the head office machine, into a shop-side storage unit as the shop master data before application.

[Supplementary Note 9]

The master data maintenance method according to Supplementary Note 7 or 8, further comprising a step of confirming, by the head office machine, before maintenance on the head office master data is performed, whether the head office master data is head office master data that has been subjected to maintenance last time in the head office machine, or head office master data that has been further subjected to maintenance in the shop machine after being subjected to maintenance last time in the head office machine.

[Supplementary Note 10]

The master data maintenance method according to Supplementary Note 9, further comprising a step of performing, by the head office machine, when the head office machine has confirmed that the head office master data is not the head office master data that has been subjected to maintenance last time in the head office machine, or the head office master data that has been further subjected to maintenance in the shop machine after being subjected to maintenance last time in the head office machine, maintenance on the head office master data that has been subjected to maintenance last time in the head office machine.

[Supplementary Note 11]

The master data maintenance method according to any one of Supplementary Notes 7 to 10, further comprising a step of identifying, by the head office machine, whether the head office master data is head office master data that has been subjected to maintenance in the head office machine, or head office master data that has been subjected to maintenance in the shop machine.

[Supplementary Note 12]

A POS terminal device, which is connected to a head office machine installed in a head office via a network in a manner that enables data communication to/from the head office machine and is installed in a shop, the POS terminal device being allowed to perform maintenance on master data to be used when the POS terminal device performs processing related to a product sale,
the POS terminal device comprising:
   a shop-side control unit; and
   a shop-side storage unit configured to hold in-use shop master data, which is currently used, and shop master data before application, which has been subjected to maintenance in the head office machine or the own shop machine,
wherein, when the shop master data before application is determined as being usable as the in-use shop master data, the shop-side control unit transmits the in-use shop master data to the head office machine.

[Supplementary Note 13]

The POS terminal device according to Supplementary Note 12, wherein the shop-side control unit is configured to store head office master data before application, which is stored in a head-office-master-before-application area for storing head office master data that has been subjected to maintenance in the head office master data as the head office master data before application, into the shop-side storage unit as the shop master data before application.

[Supplementary Note 14]

The POS terminal device according to Supplementary Note 12 or 13, wherein the shop-side control unit is allowed to identifying whether the shop master data before application is shop master data that has been subjected to maintenance in the head office machine, or shop master data that has been subjected to maintenance in the shop machine.

This application is based upon and claims the benefit of priority from Japanese Patent Application No. 2016-199981, filed on Oct. 11, 2016, the disclosure of which is incorporated herein in its entirety by reference.

### REFERENCE SIGNS LIST

1, 100 . . . POS system
11 . . . head office-side storage unit
21 . . . shop-side storage unit
10, 110 . . . head office machine
111 . . . input unit
112 . . . display unit
113 . . . communication unit
12, 114 . . . head office-side control unit
115 . . . head office-side storage unit
20, 120, 120-1 to 120-N . . . shop machine
121 . . . input unit
122 . . . clerk display unit
123 . . . customer display unit
124 . . . printing unit
125 . . . communication unit
22, 126 . . . shop-side control unit
127 . . . shop-side storage unit
30, 130 . . . network
210, 210A, 210B, 210C . . . individual shop product master area
210-1, 210-1A, 210-1B, 210-1C . . . individual shop product master data
220, 220A, 220B . . . product-master-before-application area
220-1, 220-1B . . . product master data before application
230, 230A, 230B. 230C . . . individual shop data area
230-1, 230-1A, 230-1B, 230-1C . . . individual shop data
310 . . . shop-master-before-application area
320 . . . in-use shop master area
330 . . . sales data area
400 . . . information processing device
410 . . . control unit
420 . . . storage device
430 . . . ROM
440 . . . RAM
450 . . . communication interface

1. A POS system, comprising a shop machine installed in a shop and configured to perform processing related to a product sale, and a head office machine installed in a head office, the shop machine and the head office machine being connected to each other via a network in a manner that enables data communication to/from each other, the POS system being capable of performing, in the head office machine and the shop machine, maintenance on master data to be used when the shop machine performs the processing related to the product sale,
wherein the head office machine includes:
a head office-side control unit; and
a head office-side storage unit configured to hold head office master data,
wherein the shop machine includes:
a shop-side control unit; and
a shop-side storage unit configured to hold in-use shop master data, which is currently used, and shop master data before application, which has been subjected to maintenance in the head office machine or the shop machine,
wherein the shop-side control unit is configured to transmit, in response to switching the shop master data before application to the in-use shop master data, the in-use shop master data to the head office machine, and
wherein the head office-side control unit is configured to store the in-use shop master data received from the shop machine into the head office-side storage unit as new head office master data.

2. The POS system according to claim 1,
wherein the head office-side storage unit includes a head-office-master-before-application area configured to holding head office master data that has been subjected to maintenance in the head office machine, as head office master data before application, and
wherein the shop-side control unit is configured to store the head office master data before application, which has been stored into the head-office-master-before-application area, into the shop-side storage unit as the shop master data before application.

3. The POS system according to claim 1,
wherein the head office-side control unit is configured to transmit head office master data that has been subjected to maintenance in the head office machine, to the shop machine as head office master data before application, and
wherein the shop-side control unit is configured to store the received head office master data before application into the shop-side storage unit as the shop master data before application.

4. The POS system according to claim 1, wherein, before maintenance on the head office master data is performed, the head office-side control unit confirms whether the head office master data is head office master data that has been subjected to maintenance last time in the head office machine, or head office master data that has been further subjected to maintenance in the shop machine after being subjected to maintenance last time in the head office machine.

5. The POS system according to claim 4, wherein, when the head office-side control unit has confirmed that the head office master data is not the head office master data that has been subjected to maintenance last time in the head office machine, or the head office master data that has been further subjected to maintenance in the shop machine after being subjected to maintenance last time in the head office machine, the head office-side control unit performs maintenance on the head office master data that has been subjected to maintenance last time in the head office machine.

6. The POS system according to claim 1, wherein the head office-side control unit is allowed to identify whether the head office master data is head office master data that has been subjected to maintenance in the head office machine, or head office master data that has been subjected to maintenance in the shop machine.

7. A master data maintenance method, which is executed in a configuration in which a shop machine installed in a shop and configured to perform processing related to a product sale and a head office machine installed in a head office are connected to each other via a network in a manner that enables data communication to/from each other and, in the head office machine and the shop machine, maintenance is performed on master data to be used when the shop machine performs the processing related to the product sale,
the master data maintenance method comprising the steps of:
transmitting, by the shop machine, in response to switching shop master data before application that has been subjected to maintenance in the head office machine or the shop machine to in-use shop master data in the shop machine, the in-use shop master data to the head office machine; and
storing, by the head office machine, the received in-use shop master data into a head office-side storage unit as new head office master data.

8. The master data maintenance method according to claim 7, further comprising a step of storing, by the shop machine, the head office master data that has been subjected to maintenance in the head office machine, into a shop-side storage unit as the shop master data before application.

9. The master data maintenance method according to claim 7, further comprising a step of confirming, by the head office machine, before maintenance on the head office master data is performed, whether the head office master data is head office master data that has been subjected to maintenance last time in the head office machine, or head office master data that has been further subjected to maintenance in the shop machine after being subjected to maintenance last time in the head office machine.

10. The master data maintenance method according to claim 9, further comprising a step of performing, by the head office machine, when the head office machine has confirmed that the head office master data is not the head office master data that has been subjected to maintenance last time in the head office machine, or the head office master data that has been further subjected to maintenance in the shop machine after being subjected to maintenance last time in the head office machine, maintenance on the head office master data that has been subjected to maintenance last time in the head office machine.

11. The master data maintenance method according to claim 7, further comprising a step of identifying, by the head office machine, whether the head office master data is head office master data that has been subjected to maintenance in the head office machine, or head office master data that has been subjected to maintenance in the shop machine.

12. A POS terminal device, which is connected to a head office machine installed in a head office via a network in a manner that enables data communication to/from the head office machine and is installed in a shop, the POS terminal device being allowed to perform maintenance on master data to be used when the POS terminal device performs processing related to a product sale,
the POS terminal device comprising:
a shop-side control unit; and
a shop-side storage unit configured to hold in-use shop master data, which is currently used, and shop master data before application, which has been subjected to maintenance in the head office machine or the shop machine,
wherein, in response to switching the shop master data before application to the in-use shop master data, the shop-side control unit transmits the in-use shop master data to the head office machine.

13. The POS terminal device according to claim 12, wherein the shop-side control unit is configured to store head office master data before application, which is stored in a head-office-master-before-application area for storing head office master data that has been subjected to maintenance in the head office master data as the head office master data before application, into the shop-side storage unit as the shop master data before application.

14. The POS terminal device according to claim 12, wherein the shop-side control unit is allowed to identifying whether the shop master data before application is shop master data that has been subjected to maintenance in the head office machine, or shop master data that has been subjected to maintenance in the shop machine.
